(19) United States
(12) Patent Application Publication
(10) Pub. No.: US 2026/0336187 A1
(43) Pub. Date: Oct. 29, 2026

(54) Film Extrusion Machine, and Method for Producing a Plastic Film

(71) Applicant: Windmöller & Hölscher KG, Lengerich (DE)

(72) Inventor: Martin BACKMANN, Lengerich (DE)

(21) Appl. No.: 19/120,613

(22) PCT Filed: Oct. 13, 2023
(86) PCT No.: PCT/EP2023/078535

§ 371 Date: May 13, 2025

(30) Foreign Application Priority Data
Oct. 14, 2022 (DE) 10 2022 210 858.2

(51) Int. Cl. B29C 48/10; B29C 48/88; B29C 48/92

(52) U.S. Cl. CPC B29C 48/10; B29C 48/912; B29C 48/92; B29C 2948/92085; B29C 2948/92447

(57) ABSTRACT

The invention relates to a film extrusion machine, in particular a blown film extrusion machine, for producing a plastic film, said machine comprising: a die, in particular an annular die, for providing a plastic melt; and at least one draw-off roller, which is arranged downstream of and at a distance from the die, for drawing off the plastic melt, which has solidified in a frost zone to form a plastic film, in a transport direction, wherein the draw-off roller rotates at a peripheral speed. A speed determination device is provided for determining the local transport speed of at least a partial area of the plastic melt and/or of the plastic film.

The invention relates to a film extrusion machine, in particular a blown film extrusion machine, for producing a plastic film according to the preamble of claim 1 and to a method for producing a plastic film according to the preamble of claim 7.

To produce a plastic film, a plastic granulate or a mixture of several plastic granulates is usually melted and liquefied in an extruder using a heater and by applying pressure. This molten plastic is conveyed in strand form into a die head, where it is distributed over a wide area in a distributor. This plastic melt, which is distributed over a large area, is then pressed out of the die of the die head due to the pressure, so that the die makes the plastic melt available. The die can be a linear die (flat die) or an annular die. The former die is used for so-called flat film extrusion, while the latter die is used for blown film extrusion. Accordingly, the melts form either a flat melt or a melt bubble. Several extruders are often used to produce several individual melts, which are combined in the die head to form a multi-layer plastic melt. This single-layer or multi-layer plastic melt is drawn out of the die by at least one draw-off roller, whereby the draw-off roller is arranged at a distance from the die. On its way to the draw-off roller and/or during contact with the draw-off roller, the plastic melt cools down to such an extent that it forms the plastic film to be produced. The transition area in which the plastic melt solidifies and becomes a plastic film is often referred to as the frost zone or frost line, as the molten plastic freezes, as it were, in this area.

In a blown film extrusion machine, further components are arranged in the transport direction of the plastic melt or the plastic film (hereinafter also referred to as “melt” or “film”). These can include an internal cooling device which extends from the die head in the transport direction of the melt or film and is arranged inside the die. With this internal cooling device, a slight overpressure can be introduced into the interior of the melt bubble and thus inflated transverse to the transport direction, i.e. stretched. The peripheral speed of the draw-off rollers is generally greater than the outflow speed of the melt from the annular die, so that the melt can also be stretched or is stretched in the transport direction. Furthermore, a calibration cage and/or a flattening device can be provided downstream of the annular die. With a calibration cage, the melt bubble or the tube of the film can be brought into a circular shape or held in this shape. With a flattening device, the tube of the film can be successively flattened and transformed into a double-layered film. This makes it easy to remove the film from the draw-off roller. A pressure roller is often attached to the draw-off roller to prevent the film from slipping on the draw-off roller.

In a flat film extrusion line, the melt brought into the width is fed, usually under the influence of gravity, onto a draw-off roll designed as a chill roll, whereby the draw-off roll is arranged at a distance from the flat die. The peripheral speed of the chill roll is generally greater than the speed at which the melt flows out of the flat die. On the tempered cooling roller, the melt solidifies to form a film, whereby this area is also referred to as the frost zone. On the way from the flat die to the draw-off roller, the properties of the melt can be influenced by means of electrodes and/or suction elements (so-called vacuum boxes), for example.

One disadvantage, however, is that the flow behavior of the melt, which has not yet become a film, is very sensitive to external influences. Different temperature distributions in the extruders can lead to inhomogeneous properties of the melt. Contamination or other external influences, such as draughts in the production hall where the film extrusion machine is installed, can also lead to different temperature behavior within the melt. Such inhomogeneities in turn lead to different flow behavior over the length of the melt between the die and the frost zone and/or in the transverse direction. However, such differences are transferred to the film in the frost zone, so that the film can have a different quality over its length and/or width. However, the detection of such inhomogeneities in the melt and/or in the film is sometimes difficult or not possible. Accordingly, unsuitable settings are often made on film extrusion machines, for example for positions of machine components, but also for parameter controls or control loops.

The task of the present invention is therefore to propose a detection option for inhomogeneities within the melt and/or the film.

According to the invention, this task is solved by all the features of claim 1. Possible embodiments of the invention are given in the dependent claims.

According to the present invention, a speed determining device is provided for determining the local transport speed of at least a partial area of the plastic melt and/or the plastic film.

The local transport speed is therefore determined by the melt and/or the film, in particular by the surface, for a partial area. The transport speed of the melt and/or the film usually varies greatly between the die and the frost zone. Directly on exiting the die, the melt has a low local transport speed, but this increases considerably, at least for partial areas, due to the higher peripheral speed of the draw-off roller. In blown film lines in particular, the local transport speed increases as the film is stretched due to the internal pressure applied by the internal cooling. As the melt cools, the transport speed approaches the peripheral speed of the draw-off roller. The local transport speed is basically a three-dimensional vector, the direction of which can be oriented differently relative to the transport direction, with one component running parallel to the transport direction. If the local transport speeds are determined for several partial areas, a speed vector field can be created from this. It is advantageous if the local speeds are determined for at least 30%, preferably at least 50% of the total width or the total circumference of the melt or film after leaving the die for partial areas. The local speeds can be absolute local speeds or relative local speeds. To determine relative speeds, the local speeds of a partial area can be recorded over a period of time and an average can be formed from this. The deviations from this average local speed are then the relative local speeds. Instead of or in addition to averaging over time, the local speeds of neighboring partial areas can also be used. A calculation and control device is provided to calculate these average values and the relative local speeds. The speed determination device preferably comprises detection devices such as sensors or cameras, which in particular enable a spatially resolved determination of the local speeds. These detection devices are of course connected to the calculation and control device via a data line.

The melt and/or the film can be characterized by determining the local speeds. It is known that areas of the melt with higher temperatures in particular melt more strongly compared to other areas. A higher local speed can therefore be detected in these areas. Such areas can therefore lead to localized thin spots in the subsequent film. An inhomogeneous layer composition of the melt can also lead to different local speeds, as the individual layers can exhibit different cooling behavior. Overall, different local speeds represent possible inhomogeneities in the melt and/or the film. The local speeds determined can therefore serve as a basis for improved settings on the film extrusion machine. Advantageously, the device according to the invention works independently of the plastic materials processed in the melt or in the film. It is also independent of the (average) thickness of the melt or the film.

The speed determination device according to the invention with the embodiments just described can be combined not only with a film extrusion machine, but in principle with machines in plastics processing in which warmed or heated plastics cool down. One possible combination includes, for example, devices in which a plastic film is heated and then cooled again. This includes a stretching device in which a plastic film is heated to a temperature up to a temperature range between the melt temperature and a temperature that is up to 20 degrees Celsius below the melt temperature, then stretched in the transport direction and then cooled again. Such a device comprises a heating device for heating the plastic film, a first stretching roller which is operated at a peripheral speed, a second stretching roller which is operated at a peripheral speed which is greater than the peripheral speed of the first stretching roller and an optional cooling and/or fixing unit.

In this process, the plastic film is stretched longitudinally, whereby the film width decreases and the edges thicken at the same time (so-called neck-in). The general aim of this process is always to reduce the thickening of the edges, as these thickenings cannot be used in the further processing of the film and must be removed. It is therefore expedient to use a speed determination device described above to determine local speeds of partial areas of the film. A speed determination device according to the invention can therefore be advantageously used in such a stretching device.

Other devices are those that produce a molded plastic part 15 from plastic material that has a temperature above its melting temperature, for example by injection molding, blow molding and the like. Calendering devices can also be combined with a speed determination device described above. All the above and also the following features can be combined with such devices, even if they are only described in connection with film extrusion machines.

In an advantageous embodiment of the invention, it is provided that the deviation of the local transport speed of a partial area from the peripheral speed of the draw-off roller can be calculated using a calculation and control device, whereby this partial area can be assigned to the plastic film in the event of a deviation below a threshold value. This therefore means that the local transport speed is determined for one or more partial areas, whereby this is in particular an absolute local transport speed. This transport speed is compared with the peripheral speed of the draw-off roller by forming a difference. If the amount of this difference is below a threshold value, i.e. within a tolerance range, the compared speeds can be regarded as the same. This partial area is then assigned to the plastic film, i.e. to a location where the plastic film has already been formed.

This means that the frost zone has already been passed through. If the process conditions in the film extrusion machine are constant, the frost zone is usually stationary. It is therefore possible to carry out this procedure one after the other or simultaneously for different partial areas. In this way, the exact position of the frost zone can be determined.

In a further, advantageous embodiment of the invention, it is provided that the film extrusion machine is a blown film extrusion machine with a calibration cage, wherein the calibration cage can be positioned downstream of the position of the frost zone using the calculation and control device. In particular, the calibration cage can be positioned a maximum of 2 meters, preferably a maximum of 1 meter and in particular a maximum of 0.5 meters downstream of the frost zone. A calibration cage is used to ensure that the film, which has become a film tube in the frost zone 15, no longer changes in diameter and also approximates a circular shape. For this purpose, a calibration cage comprises film guide elements that are arranged around the outside of the circumference of the film tube and thus circumscribe the film tube. Since contact between the film guide elements and the film tube is intended or—in the case of non-contact guide elements-cannot be ruled out, the aim is to always position the calibration cage downstream of the frost zone in order to avoid damage to the film by the film guide elements. With the device according to the invention, the position of the frost zone can also be determined if the calibration cage covers this frost zone, i.e. in particular if the calibration cage is not yet suitably positioned in the frost zone.

In an advantageous embodiment of the invention, it is provided that the speed determination device can be used to determine the local transport speeds of a plurality of partial areas transversely to the transport direction, whereby deviations of the local transport speeds from an average transport speed can be determined with the calculation and control device, whereby a thickness profile of the plastic film can be derived from the deviations. Particularly in a blown film line, the control of a uniform film thickness of the subsequent film over its width or over its circumference is of particular importance.

In known film extrusion machines, the film thickness is measured with thickness measuring systems downstream of the frost zone and these measured values are used for a different influencing of the melt transversely to its transport device. However, there is a time lag between the measurement and the influencing of the film, which can be reduced by the film extrusion device according to the invention, since the speed can now also be determined at the melt, i.e. upstream of the frost zone. In this context, it is advantageous if the device comprises a temperature control device, in particular a cooling device, which comprises several segments distributed over the circumference of the melt or the film, whereby each segment can be used to apply an air flow to the melt or film, which can be adjusted differently with regard to the volume flow rate and/or with regard to the temperature. This setting can then be made by the calculation and control device for each segment. In addition or alternatively, the invention makes it possible to determine length tolerances, in particular length tolerances with regard to the film thickness, i.e. thickness changes, in the transport direction of the film tube.

It is particularly advantageous that the film extrusion device according to the invention can be used to simultaneously determine deviations from the local transport speeds both in the transport direction and transversely thereto. This means that the local film thickness 25 can be determined not only at one position over the circumference, but also at various positions in the transport direction, i.e. in the longitudinal direction. In this way, it is also possible to determine the development of differences in the melt or film thickness at least partially in the transport direction. It is thus also possible to use the device according to the invention to determine the quality of the flatness of the film. In particular, a control circuit can also be provided to improve the flatness of the film.

However, the melt and film thickness can only be determined relative to an average film thickness. A film thickness measuring device can be provided in the film extrusion machine for determining an average film thickness.

In this case, the measured values of the film thickness gauge are taken into account by the calculation and control device when determining the local deviations.

In a preferred embodiment of the invention, it is provided that the speed determination device comprises at least one infrared camera with which infrared images of the plastic melt and/or the plastic film can be recorded, a calculation and control device being provided, with which an average temperature for a plurality of partial areas of the surface of the plastic melt or the plastic film can be determined from a plurality of infrared images, whereby at least one temperature deviation from the average temperature can be determined, whereby the transport speed of this temperature deviation along the surface of the plastic melt or the plastic film can be determined. A temperature can be determined by means of an infrared camera in such a way that the radiation intensity of a defined infrared wavelength range is determined. The radiation intensity depends, among other things, on the temperature. The calculation and control device can be used to average several successively recorded temperature values for each partial area so that an average temperature can be formed for each partial area. This average temperature can, of course, be formed dynamically, which means that the most recently recorded temperature values are taken into account when a new average is formed. However, if there is a deviating temperature for a partial area, this represents an inhomogeneity in the film in this partial area. If, after a time interval, this or a similar pattern of temperature deviations is detected in a neighboring or at least a nearby partial area, the local speed of the melt or the film can be determined from this. Interfering influences, in particular interfering contours, such as an internal cooling device, are easy to detect, as the temperature influences caused by them are stationary and can therefore be taken into account, for example by being calculated out by the calculation and control device. This is particularly advantageous when it comes to determining the absolute temperature.

An absolute temperature can be determined by means of the calculation and control device for at least a partial area if a reference temperature is known. For example, a temperature measuring unit can be integrated in the die head, with which the die head temperature in the area of the die can be measured. This die head temperature is in equilibrium with the melt temperature in this area, so that the melt temperature can be inferred from the measured temperature values. However, it is not necessary for the temperature values recorded for each partial area and the average values formed from them to be used to calculate the local speeds. For example, the method described can be used to determine a temperature distribution of the film bubble, in particular between the die and the calibration device. By determining the deviations in a partial area from the average value formed, fluctuations in the temperature can generally be determined, for example in order to be able to determine changing properties of the film, such as the thickness distribution.

It is advantageous if the infrared camera comprises a two-dimensional sensor so that the radiation originating from different parts of the surface of the melt or the film can be detected at the same time. With such a sensor, more than one detection (so-called “images”), preferably more than five detections per second, can usually be realized. An “image” can be understood as a two-dimensional matrix of radiation intensity values. With the latter detection frequency, it is also conceivable if several detections are added together. Although this reduces the effective frequency, it improves the signal-to-noise ratio. In order to improve the signal-to-noise ratio, several cameras can also be provided so that either the images of the same partial areas are correlated between the cameras or several sensor areas within one camera detect the radiation of a single partial area of the melt or the film. Additional cameras can also be provided to detect larger areas of the melt or film. In the case of a blown film line, for example, it is conceivable to distribute at least two cameras, preferably at least three cameras and in particular at least four cameras evenly around the circumference.

Instead of one or more infrared cameras, cameras with other types of sensors can also be provided, for example color cameras or cameras with vibration sensors.

It is also advantageous if the device comprises a data memory in which at least one speed profile or at least one speed vector field of a film production can be stored. For a current film production, for example, the current speed profile can be compared with an older speed profile by means of the control and calculation device and advantageous adjustments to the process and/or setting parameters for the current film production of the film extrusion machine can be derived. A stored speed profile can also be transmitted to another film extrusion machine via a data connection. There, the values can be scaled to different machine parameters so that a stored speed profile is also available on this other film extrusion machine.

The above task is also solved by a method for producing a plastic film with a film extrusion machine, in particular a blown film extrusion machine, wherein a plastic melt is provided with a die of the film extrusion machine, in particular an annular die, and wherein the plastic melt solidified in a frost zone to form a plastic film is drawn off in a transport direction with at least one draw-off roller arranged downstream of and at a distance from the die, wherein the draw-off roller rotates at a peripheral speed.

The method according to the invention is characterized in that the local transport speed of at least a partial area of the plastic melt and/or the plastic film is determined using a speed determination device.

This method achieves the same advantages that have already been described in connection with the film extrusion device according to the invention. Also, this method is not limited to a film extrusion machine 5 in combination with the production of a plastic film, but can also be combined with other devices, as described above.

Further advantages, features and details of the invention are shown in the following description, in which various embodiments are explained in detail with reference to the figures. The features mentioned in the claims and in the description can each be essential to the invention individually or in any combination of mentioned features. In the context of the entire disclosure, features and details which are described in connection with the method according to the invention naturally also apply in connection with the film extrusion machine according to the invention and vice versa, so that reference is or can always be made to the individual aspects of the invention reciprocally with respect to the disclosure. The individual figures show:

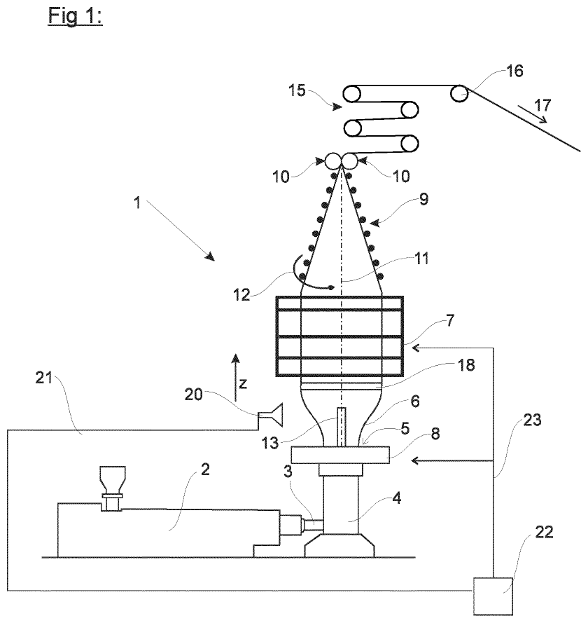

FIG. 1 Side view of a blown film line according to the invention

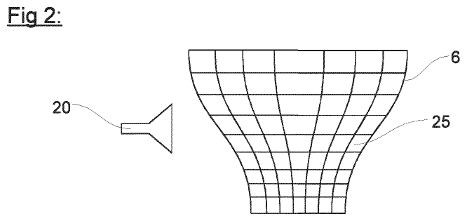

FIG. 2A sectional enlargement of FIG. 1

FIG. 1 shows a film extrusion machine, namely a blown film line 1, which comprises at least one extruder 2 with which plastic in granular form, for example, can be plasticized. The plastic melt produced in this way is fed via a line 3 to a die head 4, from which this melt can be transferred into a film bubble 6 by pressing it out of an annular die 5, which is not visible. The melt emerging from the die can now be removed. There is now a melt bubble 6 that has not yet solidified. This is inflated from the inside by a slight overpressure in a tube formation zone so that it has a larger diameter inside the calibration cage 7. For this purpose, an internal cooling device 13 is provided, which is located inside the annular die 5 and extends partially in the transport direction. This internal cooling device 13 can be supplied with air through the extrusion die.

The film bubble is solidified by cooling, whereby some of the heat from the film bubble is released into the environment. In particular, cooling air is fed to the film bubble through a temperature control device 8, which is often referred to as a cooling ring due to its ring-like design surrounding the film tube. It may be provided that the cooling air flow can be adjusted differently in terms of its volume flow and/or its temperature in different angular ranges in order to influence the film tube differently in different circumferential sections.

The solidification of the melt into a film takes place in the frost zone 18.

A calibration cage 7, whose mode of operation has already been described above, is preferably positioned downstream of the frost zone 18.

After passing through the calibration cage 7, the film bubble 6 enters the effective range of a flattening device 9, in which the circular film tube is transformed into an elliptical cross-section with increasing eccentricity until it finally forms a double-layered plastic film, which is joined together at its sides, in the area of influence of the draw-off device, which comprises two draw-off rollers 10 in particular.

The flat laying device is arranged rotatably, with the axis of rotation essentially aligned with the hose or symmetry axis 11, which is indicated by a dotted line in FIG. 1. The rotatability of the flat laying device is indicated by the arrow 12.

FIG. 1 also shows a reversing device 15, which has the task of guiding the flattened film tube from the flattening device to the stationary roller 16 without causing damage. The arrow 17 indicates that after passing through the reversing device 15, this film tube is guided for further processing, which is not specified in more detail here.

Seen in the transport direction z, at least one detection device 20 is arranged between the annular die 5 and the calibration cage 7 as part of a speed determination device, with which at least some areas of the surface of the film bubble 6 can be detected. The detection device 20 is arranged outside the film bubble 6, but is directed towards it. The detection device 20 can be attached directly or indirectly to any component of the blown film line 1. However, it is also conceivable to install the detection device 20 independently of the blown film line 1 on its own stand, for example a tripod, within the production facility.

The measured detection values of the detection device 20 are fed via a data line 21 to the computing and control unit 22, with which the data processing operations described above can be carried out.

The calculation and control device can send control commands to various components of the film extrusion system via control lines 23. The arrows on the control lines 23 show by way of example that the cooling ring can be controlled. Here, the volume flow and/or the temperature of the cooling ring 25 can be adjusted segment by segment. In addition, the calibration cage 7 can be moved in or against the transport direction z using the control commands.

FIG. 2 shows a sectional enlargement of FIG. 1. The circumferential surface of the melt or film bubble is virtually divided into partial areas 25. For each of these partial areas 25, a measured value, for example a measured temperature value, can be determined by the sensor to determine the local speed of the melt or film.

List of reference numbers

| | |
|---|---|
| 1 | Blown film line |
| 2 | Extruder |
| 3 | Line |
| 4 | Die head |
| 5 | Annular die |
| 6 | Film bubble/melt bubble |
| 7 | Calibration cage |
| 8 | Tempering device |
| 9 | Flattening device |
| 10 | Draw-off rollers |
| 11 | Tube and symmetry axis |
| 12 | Arrow |
| 13 | Indoor cooling unit |
| 14 | |
| 15 | Reversing device |
| 16 | Stationary roller |
| 17 | Arrow |
| 18 | Frost zone |
| 19 | |
| 20 | Detection device |
| 21 | Data line |
| 22 | Calculation and control unit |
| 23 | Control lines |
| 24 | |
| 25 | Partial areas |
| z | Transport direction |

1. Film extrusion machine, in particular a blown film extrusion machine, for the production of a plastic film with
a die, in particular an annular die, for providing a plastic melt,
at least one draw-off roller arranged downstream of and at a distance from the die for drawing off the plastic melt solidified in a frost zone to form a plastic film in a transport direction, the draw-off roller rotating at a peripheral speed,
characterized in that
a speed determination device is provided for determining the local transport speed of at least a partial area of the plastic melt and/or the plastic film.

2. Film extrusion machine according to claim 1,
characterized in that
a calculation and control device is provided, with which the deviation of the transport speed from the peripheral speed of the draw-off roller can be calculated, whereby in the event of a deviation below a threshold value, this partial area can be assigned to the plastic film.

3. Film extrusion machine according to claim 1,
characterized in that
the local transport speed of a plurality of partial areas can be determined with the speed determination device, whereby the deviation can be determined for each partial area and at least some of the partial areas can be assigned to the plastic film or the plastic melt, whereby a spatial position of the frost zones can be determined from the assignment.

4. Film extrusion machine according to claim 1, characterized in that the film extrusion machine is a blown film extrusion machine with a calibration cage, wherein the calibration cage can be positioned downstream of the position of the frost zone by means of the calculation and control device.

5. Film extrusion machine according to claim 1, characterized in that
the speed determination device can be used to determine the local transport speeds of a plurality of partial areas transversely to the transport direction, whereby deviations of the local transport speeds from an average transport speed can be determined with the calculation and control device, whereby a thickness profile of the plastic film can be derived from the deviations.

6. Film extrusion machine according to claim 1, characterized in that
the speed determination device comprises at least one infrared camera, with which infrared images of the plastic melt and/or the plastic film can be recorded, wherein a calculation and control device is provided, with which an average temperature for a plurality of partial areas of the surface of the plastic melt or the plastic film can be determined from a plurality of infrared images, wherein at least one temperature deviation from the average temperature can be determined, wherein the transport speed of this temperature deviation along the surface of the plastic melt or the plastic film can be determined.

7. Method for producing a plastic film with a film extrusion machine, in particular a blown film extrusion machine, wherein a plastic melt is provided with a die of the film extrusion machine, in particular an annular die,
with at least one draw-off roller arranged downstream of and at a distance from the die, which plastic melt solidified in a frost zone to form a plastic film is drawn off in a transport direction, the draw-off roller rotating at a peripheral speed, characterized in that the local transport speed of at least one partial area of the plastic melt and/or the plastic film is determined by a speed determination device.
